(19) United States
(12) Patent Application Publication
(10) Pub. No.: US 2022/0202241 A1
(43) Pub. Date: Jun. 30, 2022

(54) WRAP-AROUND GRILL LINER

(71) Applicant: Porawan BOERNER, Haymarket, VA (US)

(72) Inventor: Porawan BOERNER, Haymarket, VA (US)

(21) Appl. No.: 17/565,356

(22) Filed: Dec. 29, 2021

Related U.S. Application Data
(60) Provisional application No. 63/132,305, filed on Dec. 30, 2020.

(51) Int. Cl. A47J 37/07

(52) U.S. Cl. CPC A47J 37/0786

(57) ABSTRACT

A wrap-around grill liner includes a main portion configured to cover a plurality of grill bars of a grill and a plurality of slit patterns formed on the main portion and defining a plurality of wrap-around portions positioned to cover the plurality of grill bars, respectively. Each wrap-around portion is configured to at least partially wrap around a different one of the grill bars when pushed down.

### CROSS-REFERENCE TO RELATED APPLICATIONS

This application claims priority to and the benefit of U.S Provisional Application No. 63/132,305, titled “WRAP AROUND GRILL LINER,” filed on Dec. 30, 2020, the disclosure of which is incorporated herein by reference in its entirety.

### BACKGROUND

### 1. Technical Field

This disclosure is directed to a grill liner, more particularly to a grill liner configured to wrap-around grills bars.

### 2. Discussion of Related Art

Public grills are available at numerous places, including parks, communal areas of a residential communities, etc. To withstand repeated uses over an extended period of time, public grills are built with sturdy material such as steel, etc. Grill users are aware of the fact that someone else will use the grills and try to clean up grills once cooking is over. However, burned charcoal generates ash and other leftovers that are difficult to clean up. Also, during grilling, food (e.g., meat, sausages, etc.) leaves a burnt residue on grill bars and walls, which is difficult to remove without professional grade cleaning tools and chemical products. Therefore, public grills are very often not regarded as an acceptable option for those who are hygienically conscious.

Hence, there remains significant areas for new and improved implementations for grill liners to allow for more clean grilling experience.

### SUMMARY

In an implementation, a wrap-around grill liner includes a main portion configured to cover a plurality of grill bars of a grill; and a plurality of slit patterns formed on the main portion and defining a plurality of wrap-around portions positioned to cover the plurality of grill bars, respectively, wherein each wrap-around portion is configured to at least partially wrap around a different one of the grill bars when pushed down.

In another implementation, a wrap-around grill liner includes a plurality of side portions comprising first and second side portions facing each other and respectively configured to cover two opposite sides of a grill; and a plurality of elongated portions extending between the first and second edge portions and respectively positioned over a plurality of grill bars of the grill. Each elongated portion includes a first connection portion connected to the first side portion; a second connection portion connected to the second side portion; and a wrap-around portion extending between the first and second connection portions and configured to at least partially wrap around the grill bar when pushed down.

In another implementation, a grill liner includes a sheet configured to cover a plurality of grill bars of a grill; and a plurality of slit patterns formed on the sheet and defining a plurality of wrap-around portions configured to at least partially wrap around the grill bars, respectively. Each slit pattern includes a main slit extending substantially parallel to the grill bars and positioned over a space between a pair of the grill bars adjoining each other; and a pair of edge slits positioned at both ends of each main slit. The main slit and the pair of edge slits allow each wrap-around portion to be pushed down and at least partially wrap around the grill bar.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 illustrates a top view of a public grill.

FIG. 2 illustrates an implementation of a wrap-around grill liner.

FIGS. 3A and 3B illustrate the wrap-around grill liner of FIG. 2, which is placed over grill bars and folded down to cover an upper surface of the grill bars.

FIG. 4 illustrates another implementation of a wrap-around grill liner, which has a wide wrap-around portion.

FIGS. 5A and 5B illustrate the wrap-around grill liner of FIG. 4, which is placed over grill bars and folded down to completely wrap around the grill bars.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

To provide convenient and hygienical solutions for public grills, disposable grill liners have been developed, which are currently readily available in various shapes, sizes and configurations at grocery stores, hardware stores, grill product stores, online merchants, etc. These grill liners are typically made of a thin aluminum sheet to be easily portable, installable and disposable. Some grill liners have a number of slits or openings positioned to correspond to gaps between grill bars such that food is exposed to fire without touching the grill bars. When food is placed on such grill liner and heated, the food gets sticky and adheres to the liner. However, these grill liners typically do not have means to stay fixed on the grill bars. Hence, when a user tries to lift or flip the food, the whole grill liner is lifted together, or a portion of the grill liner gets ripped out. Further, these grill liners are typically configured to be placed on and cover grill bars, but are not configured to cover grill sidewalls, which could be as dirty and insanitary as grill bars. Hence, these grill liners do not offer any proper way to prevent food from accidentally contacting grill sidewalls.

This description is directed to a wrap-around grill liner, which may be used with grills having a plurality of grill bars. The grill liner may include a plurality of wrap-around portions that may individually wrap around the grill bars. Hence, when food is placed on the grill liner, the food may avoid making any direct contact with the grill bars. Also, the wrap-around portion that wraps around the grill bars may keep the grill liner fixed to the grill bars. Hence, when the food is heated and becomes sticky, a user can easily lift or move the food without lifting or moving the whole grill liner or ripping out the grill liner. Further, by wrapping around the grill bars, portions of the grill liner that contact the food are minimized, which may also contribute to easily lifting or moving the grilled food from the grill liner. Also, by wrapping around the grill bars, the gap between the grill bars is maximized, which may allow the food to be directly exposed to more heat and smoke, improving cooking efficiency and food taste and flavor.

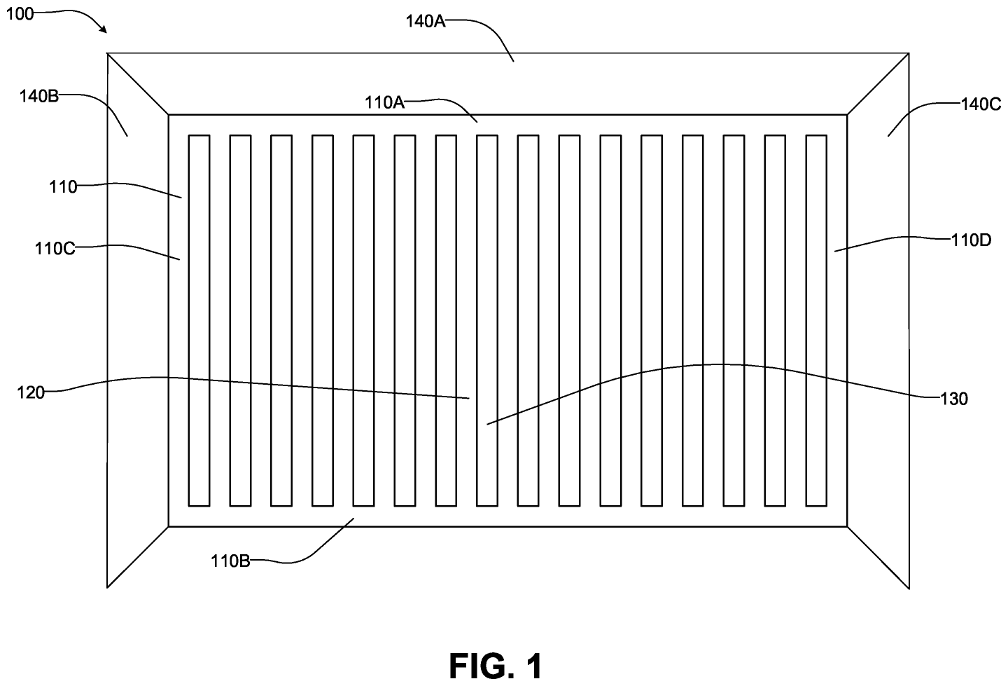

With this overview, attention is now turned to the figures to described various implementations of the present teachings. FIG. 1 is a top view of a grill 100, which may be a public grill, home grill, etc. The grill 100 includes a rectangular shaped-grill frame 110, which is formed of a plurality of elongated frame bars, such as an upper frame bar 110A, lower frame bar 110B, left frame bar 110C, right frame bar 110D, etc. The grill 100 further includes a plurality of grill bars 120 (e.g., 15 grill bars) extending between the upper frame bar 110A and lower frame bar 110B. The grill bars 120 are arranged to have a certain gap 130 therebetween. For example, the grill bars 120 may be about 38 cm long and may have an elongated tube shape having a diameter of about 1.5 cm. The gap or distance 130 between two adjoining grill bars 120 may be about 1.5 cm. The grill 100 further includes walls 140A, 140B and 140C to block wind, dust or other undesired debris. The invention, however, is not limited to grill lines having specific a shape, size and configuration for the grill 100 shown in FIG. 1.

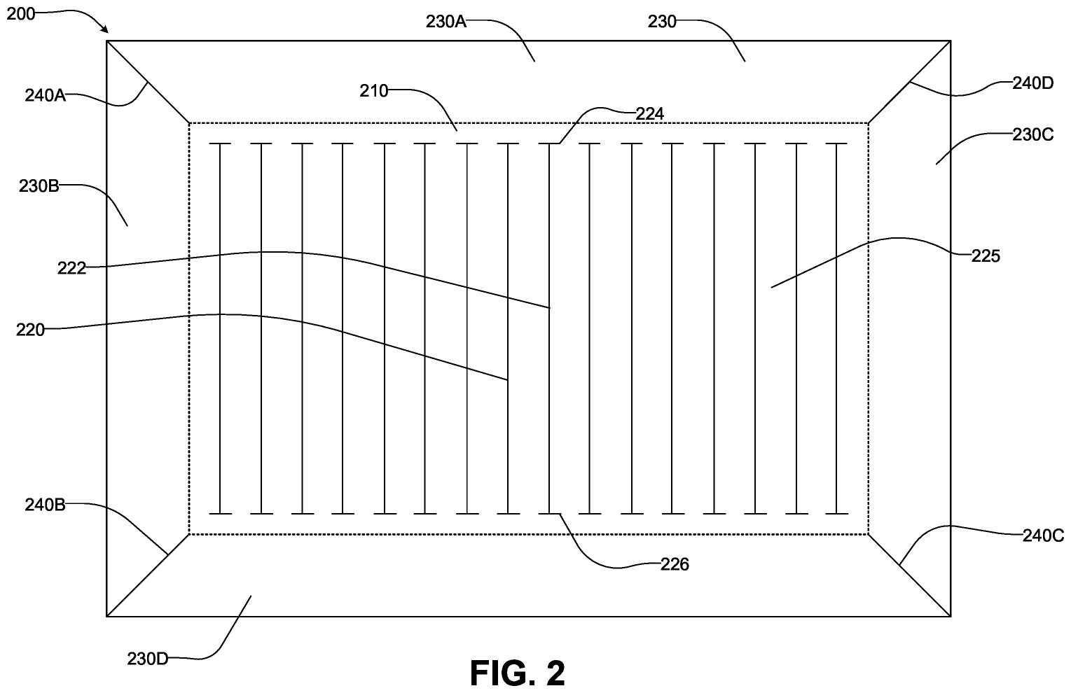

FIG. 2 is a top view of a wrap-around grill liner 200, which may be produced by cutting a sheet formed of a material that does not damage or contaminate food and is fire and heat-resistant, light, foldable and low cost (e.g., aluminum, an aluminum-based alloy, stainless steel, a nickel-based alloy, a cobalt, chrome and nickel-based alloy, a molybdenum and titanium-based alloy, etc.). Alternatively, the wrap-around grill liner 200 may be formed of food grade silicone, which is a non-toxic polymer mostly made from silica and can withstand a high temperature (e.g., 425° C. or higher). The grill liner 200 may include a main portion 210 and sidewall portion 230, which may be formed integrally. Alternatively, the main portion 210 and the side portion 230 may be produced separately and attached together by, for example, gluing, riveting, etc.

The main portion 210 may be shaped and sized to fit over the grill frame 110 including the grill bars 120 shown in FIG. 1. For example, the main portion 210 may have substantially the same width and length as the grill frame 110. The main portion 210 may include a plurality of slit patterns 220 (e.g., 16 silt patterns) which defines a plurality of wrap-around portions 225, for example, 15 complete wrap-around portions and 2 partial wrap-around portions on both sides of the complete wrap-around portions. Each wrap-around portion 225 is positioned over a different one of the grill bars 120 when the grill liner 200 is placed over the grill bars 120. The plurality of slit patterns 220 may be spaced apart from each other such that the wrap-around portions 225 are not completely separated from the other portions of the main portion 210.

Each silt pattern 220 may include a main slit 222 and two edge slits 224 and 226 formed at both ends of the main slit 222. The main slit 222 may extend substantially parallel to the grill bars 120 and may have substantially the same length as the grill bars 120. The edge slits 224 and 226 may extend substantially perpendicular to the main slit 222 and substantially parallel to the upper and lower frame bar 110A and 110B, respectively. The main slit 222 may be connected to the center of both edge slits 224. When the grill liner 200 is placed over the grill 100, the main slits 222 may be positioned over the gaps 130 of the grill 100, respectively. The edge slits 224 and 226 may be positioned near a boundary of the main portion 210. The distance between the edge slit 224 and the boundary of the main portion 210 may be sufficiently large to cover the upper frame bar 110A. The edge slit 226 may be similarly positioned to sufficiently cover the lower frame bar 110B.

Each wrap-around portion 225 may be defined by a pair of the slit patterns 220 adjoining each other. For example, each wrap-around portion 225 may include a portion of the main portion 210 that are surrounded by two adjoining slit patterns 220. The slit patterns 220 may be formed by cutting the main portion 210. Hence, portions of each wrap-around portion 225 adjoining the main slit 222 and edge slits 224 may be pushed down and folded to at least partially wrap around the underlying grill bar 120.

The sidewall portion 230 may extend from and surround the main portion 210. The main portion 210 and sidewall portion 230 may be a single unit formed by cutting an aluminum sheet. Alternatively, the sidewall portion 230 may be produced as a separate part and attached to the main portion 210. The sidewall portion 230 may include a plurality of cutouts 240A, 240B, 240C and 240D, which extend from four concerns of the main portion 210 to four outer corners of the sidewall portion 230, respectively. The cutouts 240A, 240B, 240C and 240D may divide the sidewall portion 230 into four sidewall portions 230A, 230B, 230C and 230D. The cutouts 240A, 240B, 240C and 240D may allow the sidewall portions 230A, 230B, 230C and 230D to be folded along the boundary of the main portion 210. For example, the sidewall portion 230A may be folded up to cover the sidewall 140A of the grill 100. Similarly, the sidewall portions 230B and 230C may be folded up to cover the sidewalls 140B and 140C of the grill 100, respectively. The sidewall portion 230D may be either folded down or removed to provide easier access to a cooking space over the main portion 210. The sidewall portion 240 may be sufficiently wide (e.g., about 5 cm or longer) such that food being cooked does not accidently contact the sidewalls 140A, 140B and 140C of the grill 100.

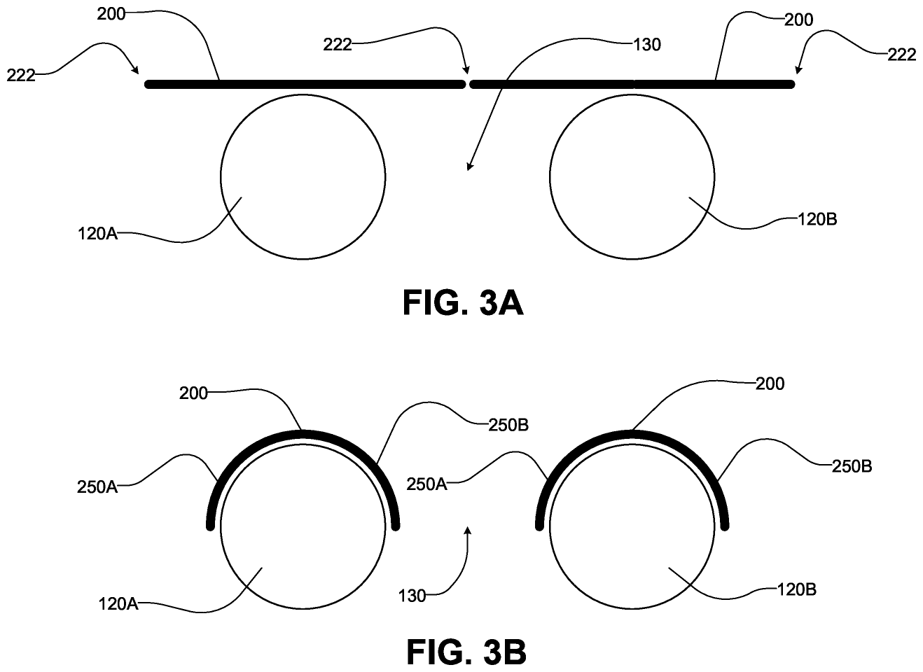

FIG. 3A shows a cut view of two adjoining grill bars 120A and 120B of the grill 100 and a portion of the grill liner 200 overlapping the grill bars 120A and 120B. When the grill liner 200 is placed over the grill 100, the main slit 222 may extend along the gap 130 between the grill bars 120A and 120B. In an implementation, the main slit 222 may be formed along a line that divide the gap 130 into two halves. Once the grill liner 200 is placed over the grill 100 and the main slit 222 is aligned with the gap 130, the grill liner 220 may be pushed down to cover the grill bars 120A and 120B. FIG. 3B shows an upper surface of the grill bars 120A and 120B covered by the portions of the grill 200 between two adjoining main slits 222. The main slit 222 and edge slits 224 and 226 allow portions of the grill liner 200 adjoining the main slit 222 to be folded down and cover the upper surface of the grill bards 120A and 120B. These portions of the grill liners 200 are referred to as wing portions 250A and 250B hereinafter. The wing portions 250A and 250B may longitudinally extend between the edge slits 224 and 226 and cover left and right upper surfaces of each grill bar 120, respectively, as shown in FIG. 3B. Accordingly, the wing portions 250A and 250B may prevent food placed on the grill liner 200 from contacting the grill bars 120A and 120B without blocking the fire and smoke from charcoal burning below the grill bars 120A and 120B.

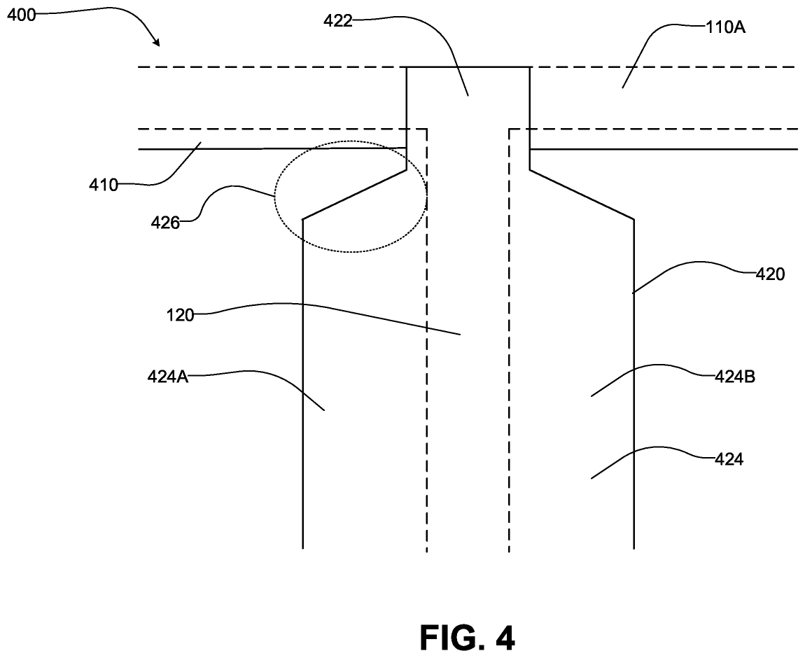

FIG. 4 is a top view of a portion of a grill liner 400 having extended wing portions to wrap around grill bars 120 more securely. The grill liner 400 may have a plurality of side portions 410 (only one shown), which may extend along the sides of the grill surface to cover the elongated frame bars 110, respectively. Each side portion 410 may have a rectangular shape to cover the grill frame 110 (only the upper frame bar 110A is shown as dotted lines).

The grill liner 400 may also include a plurality of elongated portions 420 (only one is shown) extending between two side portions 410 facing each other. Each elongated portion 420 may extend parallel to the grill bars 120 (only one grill bar 120 is shown as dotted line). Each elongated portion 420 may have connection portions 422 at both ends (only one is shown), which may be glued or riveted to the side portion 410. The elongated portion 420 may also have a wrap-around portion 424 extending between the two connection portions 422 and positioned to be aligned with the grill bar 120. The wrap-around portion 424 may be wider than the connection portions 422 and sufficiently wide to completely wrap around the grill bar 120. For example, for the grill bar 120 having a diameter of about 1.5 cm, the wrap-around portion 424 may have a width of about 5 cm or greater to completely encircle the grill bar 120. The wrap-around portion 424 may have left wing portion 424A and right wing portion 424B which may be folded down to wrap around the grill bar 120. Edges 426 of the elongated portion 420 adjoining the connection portion 422 may be cut in a diagonally inclined or curved shape to provide a clearance between the side portion 410 and wrap-around portion 424 when the wrap-around is folded down to wrap around the grill bar 120.

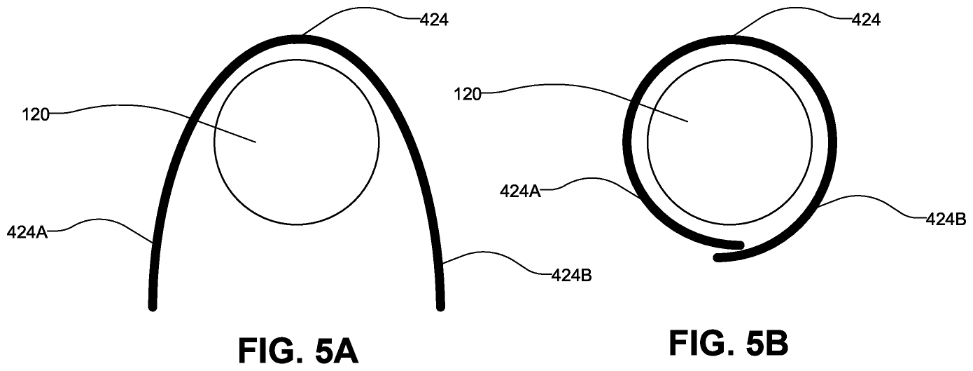

FIG. 5A is a cut view of the grill bar 120 and wrap-around portion 424. The warp-around portion 424 may be formed by cutting an aluminum sheet to have a desired shaped (e.g., the shape shown in FIG. 4), and then attached to the side portion 410. After being attached to the side portion 410, the wrap-around portion 424 may be folded to have an inversed U or V shape to avoid interfering with neighboring wrap-around portions 420. Alternatively, the wrap-around portions 424 may be folded to have an inversed U or V shape and then attached to the side portion 410 to form the grill liner 400. In another implementation, the wing portions 424A and 424B may be produced separately and attached to the elongated portion 420. For example, an aluminum sheet may be cut to form the side portion 410 and the elongated portion 420 that does not have the wing portions 424A and 424B. Then, the wing portions 424A and 424B may be attached on the left and right edges of the elongated portion 420, respectively. Alternatively, a pattern including both the left and right wing portions 424A and 424B may be formed by, for example, cutting an aluminum sheet. Such pattern and the elongated portion 420 may then be aligned together and conjoined such that the left and right wing portions 424A and 424B are placed on the left and right sides of the elongated portion 420, respectively.

Once the wrap-around portion 420 is aligned with and correctly placed over the grill bar 120, users may further fold the left and right wing portions 424A and 424B to completely encircle the grill bar 120, as shown in FIG. 5B. An aluminum sheet or other material that is used for the grill liner 400 may have a certain rigidity. Once the grill bars 120 are wrapped around by the wrap-around portions 424, the grill liner 400 may become firmly attached to the grill bars 120. Hence, even when the food being cooked has becomes sticky and adheres to the grill liner 400, the food can be easily separated from the grill liner 400 without lifting the whole grill liner 400 or ripping out the grill liner 400. Also, by wrapping around the grill bars 120, the grill liner 400 minimize blocking of the gap 130 between grill bars 120. This may allow the food to be exposed to more fire and smoke, improving cooking efficiency and food taste and flavor.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

What is claimed is:

1. A wrap-around grill liner comprising:
a main portion configured to cover a plurality of grill bars of a grill; and
a plurality of slit patterns formed on the main portion and defining a plurality of wrap-around portions positioned to cover the plurality of grill bars, respectively,
wherein each wrap-around portion is configured to at least partially wrap around a different one of the grill bars when pushed down.

2. The wrap-around grill liner of claim 1, wherein the plurality of slit patterns is spaced apart from each other with a predetermined gap therebetween.

3. The wrap-around grill liner of claim 1, wherein each wrap-around portion is defined by a pair of the slit patterns adjoining each other.

4. The wrap-around grill liner of claim 3, wherein:
each slit pattern includes:
a main slit extending substantially parallel to the grill bars and positioned over a space between a pair of the grill bars adjoining each other; and
a pair of edge slits positioned at both ends of each main slit, and
the main slit and the pair of edge slits allow each wrap-around portion to be pushed down and at least partially wrap around the grill bar.

5. The wrap-around grill liner of claim 4, wherein:
the plurality of slit pattern comprises first and second slit patterns adjoining each other,
the plurality of grill bars comprises a first grill bar positioned between the main slits of the first and second slit patterns,
the plurality of wrap-around portions comprises a first wrap-around portion defined by the first and second slit patterns, the first wrap-around portion comprising:
a first wing portion defined by the main slit and the pair of edge slits of the first slit pattern; and
a second wing portion defined by the main slit and the pair of edge slits of the second slit pattern, and
the first and second wing portions are configured to be pushed down and at least partially wrap around the first grill bar.

6. The wrap-around grill liner of claim 4, wherein the edge slits extend substantially perpendicular to the main slit.

7. The wrap-around grill liner of claim 4, wherein the main slit is connected to a center of both edge slits.

8. The wrap-around grill liner of claim 1, further comprising a sidewall portion connected to a side of the main portion and configured to be folded up to cover a sidewall of the grill.

9. The wrap-around grill liner of claim 8, wherein the main portion and the sidewall portion are formed integrally.

10. The wrap-around grill liner of claim 1, comprising a material having a predetermined rigidity to maintain a shape once folded to wrap around the grill bar.

11. A wrap-around grill liner comprising:
a plurality of side portions comprising first and second side portions facing each other and respectively configured to cover two opposite sides of a grill; and
a plurality of elongated portions extending between the first and second edge portions and respectively positioned over a plurality of grill bars of the grill, each elongated portion comprising:
a first connection portion connected to the first side portion;
a second connection portion connected to the second side portion; and
a wrap-around portion extending between the first and second connection portions and configured to at least partially wrap around the grill bar when pushed down.

12. The wrap-around grill liner of claim 11, wherein the first and second connection portions are attached to the first and second side portions, respectively.

13. The wrap-around grill liner of claim 11, wherein the wrap-around portion is wider than the first and second connection portions.

14. The wrap-around grill liner of claim 11, wherein the wrap-around portion has a width sufficient to completely wrap around the grill bar.

15. The wrap-around grill liner of claim 11, wherein an edge of the elongated portion near the first or second side portion has a diagonally-inclined or curved shape.

16. The wrap-around grill liner of claim 11, wherein the wrap-around portion comprises first and second wing portions respectively positioned at two opposite sides of the wrap-around portion and respectively configured to at least partially cover first and second halves of the grill bar.

17. The wrap-around grill liner of claim 11, wherein the first and second wing portions are folded down.

18. The wrap-around grill liner of claim 11, further comprising a sidewall portion connected to one of the side portions and configured to be folded upwardly to cover a sidewall of the grill.

19. The wrap-around grill liner of claim 11, comprising a material having a predetermined rigidity to maintain a shape once folded to wrap around the grill bar.

20. A grill liner comprising:
a sheet configured to cover a plurality of grill bars of a grill; and
a plurality of slit patterns formed on the sheet and defining a plurality of wrap-around portions configured to at least partially wrap around the grill bars, respectively,
wherein each slit pattern comprises:
a main slit extending substantially parallel to the grill bars and positioned over a space between a pair of the grill bars adjoining each other; and
a pair of edge slits positioned at both ends of each main slit,
wherein the main slit and the pair of edge slits allow each wrap-around portion to be pushed down and at least partially wrap around the grill bar.
